(19) United States
(12) Patent Application Publication
(10) Pub. No.: US 2005/0028147 A1
(43) Pub. Date: Feb. 3, 2005

(54) Emulation and native language interface testing system and method

(76) Inventor: Carlos Bonilla, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/628,960

(22) Filed: Jul. 28, 2003

(51) Int. Cl. G06F 9/45; G06F 9/44; G06F 9/46

(52) U.S. Cl. 717/138; 717/134; 717/116; 717/118; 719/328

(57) ABSTRACT

An emulation and native language interface testing system and method are presented. In one embodiment, an emulation and native language interface method tests an emulation and native language interface. As part of the emulation and native language interface method an emulation language virtual machine is initialized. Native language code is wrapped in a simulation test macro which creates simulated interfacing problems. Reactions to the simulated interfacing problems are examined when an emulation language application is run.

### FIELD OF THE INVENTION

The present invention relates to emulation (e.g., Java) processing applications.

### BACKGROUND OF THE INVENTION

Electronic systems and circuits have made a significant contribution towards the advancement of modem society and are utilized in a number of applications to achieve advantageous results. Numerous electronic technologies such as digital computers, calculators, audio devices, video equipment, and telephone systems have facilitated increased productivity and reduced costs in analyzing and communicating information in most areas of business, science, education and entertainment. Systems providing these advantageous results often involve emulation of a virtual “machine” for processing information. The information processing is often directed by both emulation language code (e.g., bytecode) and native language code. Transitioning from emulation language code to native language code can appear simple but often involves subtle complexities that can result in significant problems if not handled correctly.

Testing interfaces between the emulation language (e.g., Java code) and native language is important and typically difficult. Numerous electronic devices include processors that operate by executing programs comprising a series of instructions. These programs and their series of instructions are typically referred to as software. Software instructions include directions that guide processor device functions in the performance of useful tasks. The software code is often expressed in different configurations or languages. Source code is usually expressed in a language at one level and compiled into a different level expression. For example, emulation or virtual language (e.g., Java) source code is typically compiled into bytecode.

There can be significant differences between code expressions in various languages. Emulation languages (e.g., Java) typically offer flexible programming advantages. Emulation language code is usually more portable and mobile between system platforms than code that is native to a particular single platform. Java is one example of a high level emulation language that offers significant advantages over native languages. Java characteristics of platform independence, security, and network mobility make it particularly suitable for emerging distributed network computing environments. A Java program typically runs on a Java platform that interacts with the underlying computer system resources through application program interfaces (APIs). Since there is significant diversity of interfaces available for interacting between a Java program and various underlying operating systems, Java is relatively platform independent. This enables Java to be an effective language for distributed or network environment programming without the need for extensive specialized adaptation to the variety of devices potentially included in a network system. While Java applications can provide significant advantages, there is often advantages to utilizing native language code to perform some operations.

Although many of Java's characteristics are desirable, Java performance may not be optimal for a particular application. Native languages usually offer significant potential performance advantages. For example, instructions in Java language sometimes take longer to process than code in a native language. In some instances this can be overcome or at least mitigated by having a Java “call” to native language code (e.g., native language methods or subroutines). For example, native languages can usually be optimized for particular system hardware architectures (e.g., an embedded processor) in a manner that significantly increases performance of time critical code. Native languages also often permit implementation of specialized functionality or features. For example, utilization of legacy system data and/or accessing embedded system functionality and features of an underlying host platform (e.g., that may otherwise inaccessible in Java). However, calling native language files can be problematic.

While interaction between emulation language code and native language code can be relatively simple, some aspects are absolutely critical, inparticular the coordinated passage of information between emulation language code and native language code. A Java Native Interface (JNI) is one attempt at providing a protocol for objects in a Java emulation language to interact with a native language (e.g., C, C++, etc.). To beneficially participate in information processing, it is typically desirable for a JNI to permit a native method to interact to some extent with the internal state of a Java virtual machine instance, including pass and return data, access instance and class variables, invoke instance and class methods, access arrays, etc. It is also desirable for a JNI to support portability in these activities and a JNI typically attempts to achieve portability through the use of pointers to memory locations of other pointers, variables and/or functions.

When a JVM runs a program it designates portions of memory for a variety of things, including information extracted from class files (e.g., bytecode), objects a program instantiated, method parameters, return values, variables, and results. The JVM also designates memory for use by the JNI in providing access to pieces of the allocated memory to native language methods called by Java code. For example, a Java language call to the native language usually includes a pointer to the JNI. The native language code utilizes a Java environment variable to ask the JNI for bits of memory to use in responding to the Java language call. However, if there are problems with JNI methods that allocate the memory a number of detrimental effects and impacts can occur. For example, the native language code usually tries to access memory itself, which is not permitted in Java and typically results in a core dump. Core dumps can be detrimental for a variety of reasons, including results from relatively long running instances and/or emulation processes can be “lost”. In addition, a JVM crash or core dump can result in relatively large core dump files which occupy precious memory space without a user being aware of its occurrence. There are a number of problems a JNI method can cause, many of which may go undetected. In addition, product usage can be impacted by JNI method problems and the problems are often misinterpreted or incorrectly “diagnosed” (e.g. an out of memory issue being diagnosed as invalid pointer in JNI C code).

### SUMMARY OF THE INVENTION

An emulation and native language interface testing system and method are presented. In one embodiment, an emulation and native language interface method tests an emulation and native language interface. As part of the emulation and native language interface method an emulation language virtual machine is initialized. Native language code is wrapped in a simulation test macro which creates simulated interfacing problems. Reactions to the simulated interfacing problems are examined when an emulation language application is run.

### BRIEF DESCRIPTION OF THE DRAWINGS

The accompanying drawings, which are incorporated in and form a part of this specification, illustrate embodiments of the invention by way of example and not by way of limitation. The drawings referred to in this specification should be understood as not being drawn to scale except if specifically noted.

FIG. 1A is a flow chart of an emulation and native language interface testing method in accordance with one embodiment of the present invention.

FIG. 1B is a flow chart of a Java Native Language Interface (JNI) test method in accordance with one embodiment of the present invention.

FIG. 2 is a flow chart of a Java Native Language Interface (JNI) problem simulation process in accordance with one embodiment of the present invention.

FIG. 3 is a block diagram representation of an emulation and native language interface test architecture in accordance with one embodiment of the present invention.

FIG. 4 is a block diagram of one embodiment of a computer system on which a JNI testing system can be implemented in accordance with one embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it is understood the present invention may be practiced without these specific details. In other instances, some readily understood methods, procedures, components, and circuits have not been described in detail as not to unnecessarily obscure aspects of the current invention.

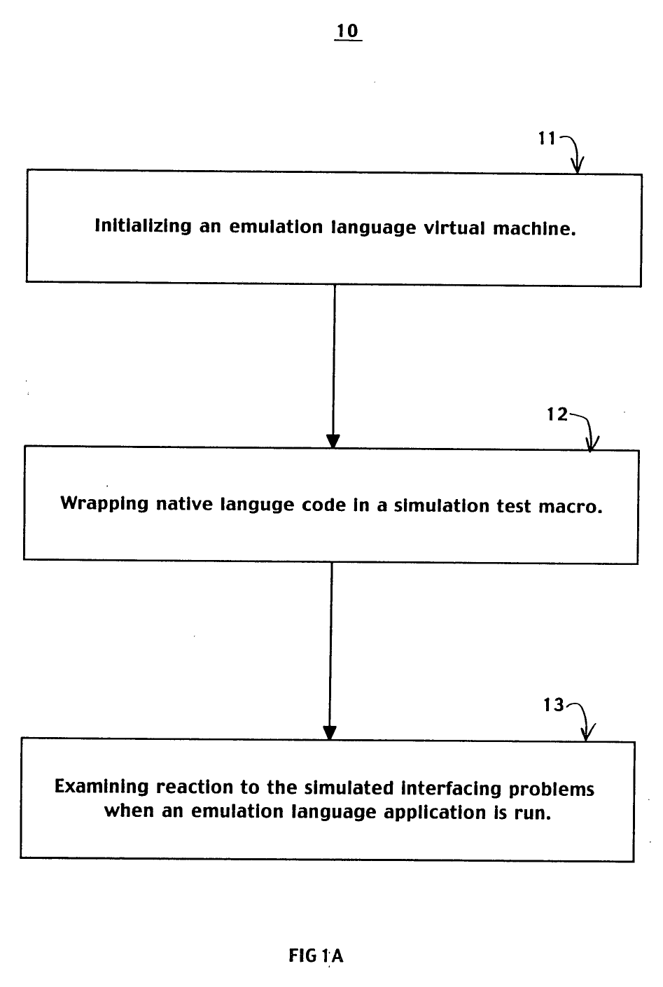

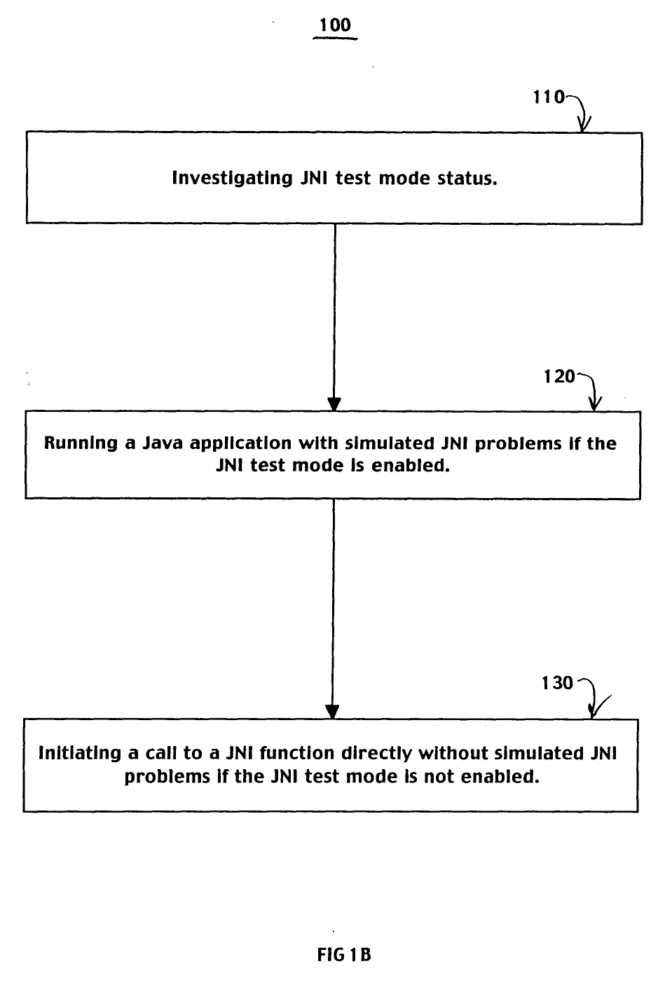

FIG. 1A is a flow chart of an emulation and native language interface testing method 10 in accordance with one embodiment of the present invention. Emulation and native language interface testing method 10 simulates interfacing problems in a test mode and examines the response to the simulated interfacing problems. For example, potential problems that can be encountered when enabling interaction between emulation language code (e.g., Java) and native language code (e.g., C, C++, etc.) are simulated. In one embodiment of the present invention, emulation and native language interface testing method 10 is implemented on an emulation language virtual machine.

In step 11, an emulation language virtual machine (e.g. a Java virtual machine) is initialized. An emulation language virtual machine creates a runtime environment. For example, a runtime environment can include a class loader subsystem and an execution engine. The behavior of an initialized emulation language virtual machine instance can be defined in terms of subsystems, memory areas, data types and instructions.

Native language code is wrapped in a simulation test macro (e.g., by an interface testing macro module) in step 12. The simulation test macro creates simulated interfacing problems. In one exemplary implementation, the simulated test problems include simulations of error conditions when a native language code method attempts to respond to a call from emulation language code. For example, an indication that there is an insufficient memory allocation exception is “forwarded” or returned to a native language method (e.g., a native language method attempting to ascertain a memory location of information associated with the native language function).

At step 13, reaction to a simulated interfacing problem is examined as an emulation language application is run in test mode. There are a variety of reactions to the simulated interfacing problems that can result. For example, the results of organized exception handling routines can be examined to ensure an exception associated with the simulated interfacing problem is handled in accordance with a predetermined process (e.g., a coordinated shut down process).

FIG. 1B is a flow chart of Java Native Language Interface (JNI) test method 100 in accordance with one embodiment of the present invention. Java Native Language Interface (JNI) test method 100 simulates JNI problems in a test mode and analyzes reactions to the simulated JNI problems. In one exemplary implementation, the simulated problems correspond to problems that can potentially be experienced when a JNI performs interfacing operations for Java bytecode and native language code (e.g., C, C++, etc.). In one embodiment, computer readable program code for causing a computer system to implement an emulation virtual machine with JNI interface testing can be embodied on a computer usable storage medium.

In step 110, JNI test mode status is investigated. For example, a determination is made if the JNI test mode is enabled (e.g., on/activated) or disabled (e.g., off/deactivated). In one embodiment, a JNI test mode status indicator indicates a JNI test mode status (e.g., enabled, disabled, activated, etc.). The JNI test mode status indicator can have a variety of configurations including a particular variable value and/or the state of a flag (e.g., set or not set). A register value can also indicate a JNI test mode status.

In step 120, a Java application with simulated JNI problems is run if the JNI test mode is enabled. Running the application with simulated JNI problems facilitates detection of potential issues with the JNI code. In one exemplary implementation, the issues include identifying indications of JNI code trouble associated with out of memory situations. For example, the problem can include insufficient memory allocation for a JVM call to a native language function (e.g., due to Java Virtual Machine Memory (JVM) allocation problems). In one embodiment of the present invention, JNI problem simulation process 200 is performed to simulate JNI problems.

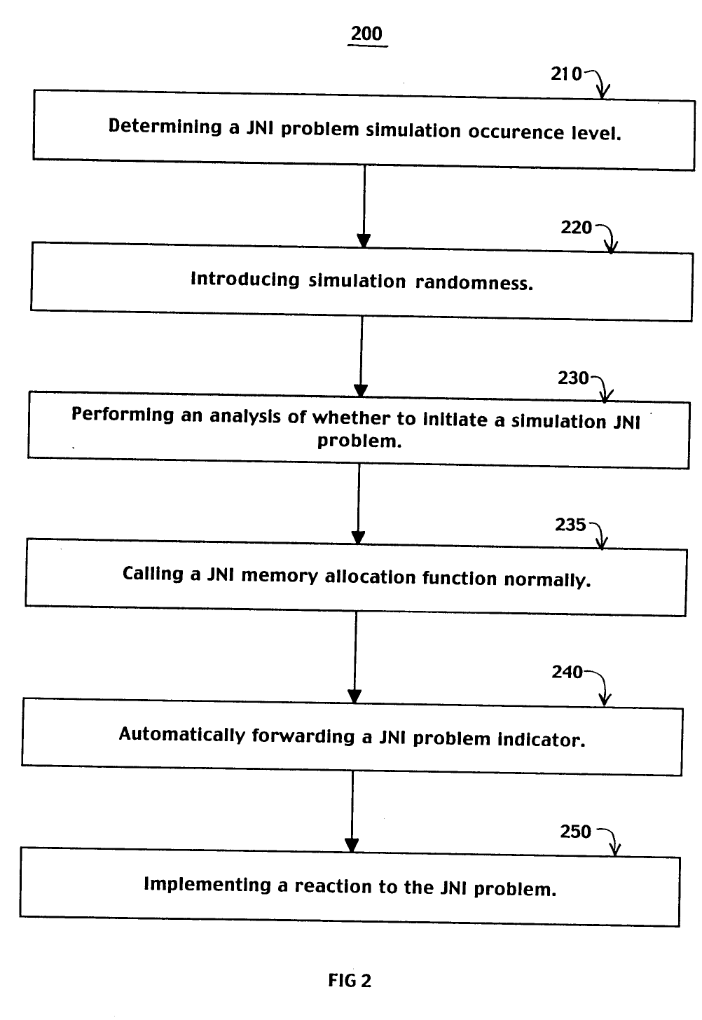

FIG. 2 is a flow chart of JNI problem simulation process 200 in accordance with one embodiment of the present invention. In one embodiment, JNI problem simulation process 200 is utilized in step 120 of Java Native Language Interface (JNI) test method 100. In one exemplary implementation, an interface testing macro module is utilized to implement JNI problem simulation process 200.

In step 210, a JNI problem simulation occurrence level is determined. The JNI problem simulation occurrence level is the percentage of times that a problem occurrence is simulated in reply to native language code trying to interface via a JNI. In one embodiment of the present invention, a predefined JNI problem simulation occurrence level (e.g., a failure simulation occurrence level) is looked up. Alternatively, a JNI problem simulation occurrence level value can be retrieved from a register.

Simulation randomness is introduced in step 220. In one embodiment, a random value is generated and it is correlated to a JNI problem simulation occurrence level. For example, a random number from 0 to 100 is generated and is assigned or utilized to indicate a JNI problem occurrence probability (e.g., probability of a memory allocation failure).

At step 230, an analysis whether to initiate a simulation of a JNI problem is performed. In one embodiment, the analysis includes comparing a randomly generated value from step 220 to the JNI problem simulation occurrence level determined in step 210. If the generated value from step 220 is less than the JNI problem simulation occurrence level determined in step 210 then a simulation of a JNI problem is initiated. If a simulation of JNI problems is initiated the process jumps to step 240. If a simulation of JNI problems is not initiated the process proceeds to 235.

With reference to step 235 shown in FIG. 2, the JNI memory allocation function is called normally. The native language code is permitted to execute normal operations. For example, the JNI returns a memory location pointer value to a request from native language code associated with a Java method call to the native language code.

With reference still to FIG. 2, a JNI problem indicator is automatically forwarded in step 240. The JNI problem indicator is forwarded or returned to the native language code attempting to intact with a JVM via the JNI. For example, a Null value indicating an out of memory status is returned.

In step 250, a reaction to the JNI problem indication is implemented. There are a variety of reactions that can be implemented including properly returning an error message to the JVM. The JVM can also be directed in a manner that avoids taking actions that could lead to an uncontrolled core dump (e.g., the native language code does not just try to access memory after receiving an out of memory indication). For example, after receiving the error message, the JVM can initiate a controlled shut down (e.g., of the impacted instance). Alternatively, the JVM can clear a system and “cancel” information (e.g., a number of megabyte “inventories”) that is occupying memory space. In one exemplary implementation, the JVM reruns the inventory collections with fewer of the inventory collections running simultaneously in parallel which frees up memory for native language calls. An indication of the JNI problem can be provided to a user or operator.

Referring now back to FIG. 1B, a call to the JNI function directly (e.g., without simulated JNI problems) is initiated in step 130 if the JNI test mode is not enabled. For example, if the test mode is not enabled, the method does not engage in testing activities that could result in the generation of a simulated random JVM memory allocation problem. In one exemplary implementation, the JNI interface test code wrapping the native language code does not participate in a memory access related process other than to determine if the JNI test mode is enabled.

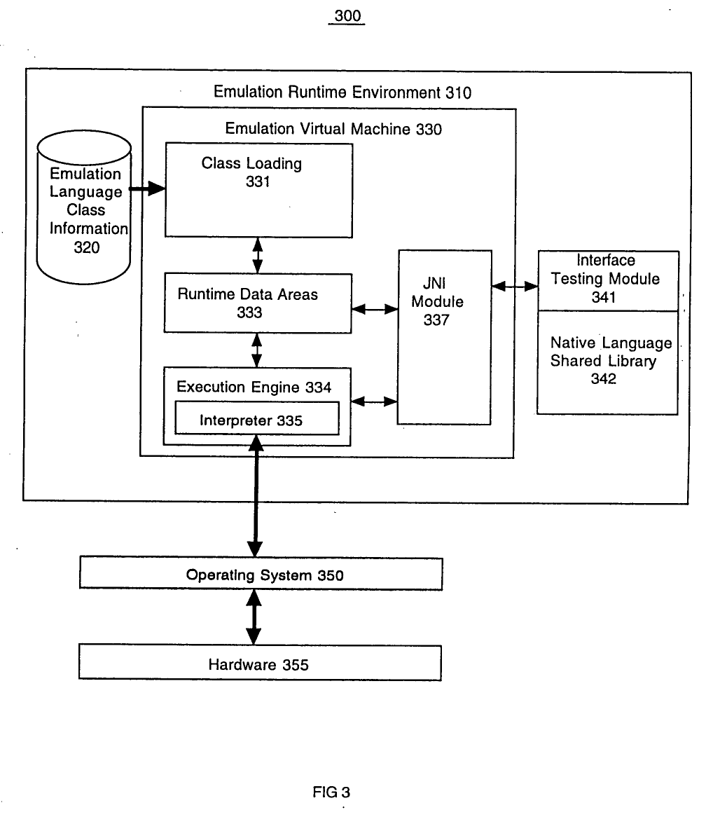

FIG. 3 is a block diagram representation of an emulation and native language interface test architecture in accordance with one embodiment of the present invention. In one exemplary implementation, the emulation and native language interface test architecture emulates a Java compatible architecture (e.g., compatible with Java virtual machine specification, Java language compatible, Java bytecode compatible, etc.). In one embodiment of the present invention, instructions for causing a computer system to implement an emulation and native language interface test architecture (e.g., JNI interface test architecture) are stored and embodied on a computer usable storage medium (e.g., as computer readable code).

An emulation and native language interface test architecture is implemented on emulation and native language interface test system 300 in one exemplary implementation. Emulation and native language interface test system 300 comprises emulation runtime environment 310, operating system 350 and hardware 355. The components of emulation native language test system 300 cooperatively operate to run an emulation application (e.g., a Java application) including testing of an emulation language and native language interface (e.g., a JNI interface). Emulation runtime environment 310 emulates a processing platform (or “machine”) for performing emulation program instructions including calling native language code for execution on operating system 350 and hardware 355. Operating system 350 controls the utilization of hardware 355. Hardware 355 includes physical components that perform information manipulations specified by emulation runtime environment 310.

In one embodiment of the present invention, emulation runtime environment 310 includes emulation language class information 320 (e.g., Java class information), emulation virtual machine 330, native language shared library information 342 and memory failure testing module 341. Emulation virtual machine 330 provides a platform-independent instruction execution “mechanism” for abstracting and coordinating operating system and processor instructions in a manner that provides emulation processing and emulation and native language interface testing. In one embodiment, emulation language class information 320 comprises bytecodes (e.g., code capable of running on multiple platforms) that provide instructions and data for execution and processing by emulation virtual machine 330. Native language shared library information 342 comprises native language code instructions associated with emulation class information 320. Memory failure testing module 341 performs emulation language and native language interface testing (e.g., method 10, 100, 200, etc.).

With reference still to FIG. 3, emulation virtual machine 330 comprises emulation class loading module 331, emulation runtime data area module 333, emulation execution engine module 334 and emulation/native language interface module 337 in one embodiment. Emulation virtual machine 330 uses a variety of techniques to execute bytecodes (e.g., Java bytecodes) in software and/or varying degrees of hardware. Class loading module 331 loads emulation language class information. Runtime data area module 333 defines and tracks assignment of logical memory locations associated with executing methods and processing data of loaded classes. Execution engine module 334 provides a “mechanism” for executing instructions and processing data included in bytecodes of loaded classes. Emulation/native language module 337 provides interfacing between emulation language methods and native language methods.

Emulation class loading module 331 places emulation class information into memory (e.g., runtime data area 233) for processing. In one embodiment of the present invention, emulation class loading module 231 is Java compatible. In one embodiment of the present invention, emulation class information includes Java classes. Java classes are code segments defining objects which are instances of a class (e.g., “component” characteristics or features included in the class). The Java class definitions can include fields and methods. The fields or class variables (“variables”) can include data (e.g., integers or characters) which can be private data accessible by a single class or public data accessible by a plurality of classes. The data can also be characterized as static data associated with class objects as a whole (e.g., common to each instance of the class) or dynamic data associated with class objects individually. The methods perform tasks or functions (e.g., a subroutine). The methods can also call other methods via invocations and/or can pass data to other objects.

Runtime data area 333 can be flexibly adapted to be compatible with a variety of different memory characteristics. In one embodiment, each instance of emulation virtual machine 330 has a method area and a heap area which can be shared by multiple threads running inside the emulation virtual machine 330. When emulation virtual machine 330 loads class file information, it parses type information from the binary data contained in the class file and places this type information into a method location of runtime data area 333. As an emulation language program (e.g., Java program) proceeds, emulation virtual machine 330 places objects the emulation language program instantiates onto a heap location of runtime data area 333. Runtime data area 333 can include a stack area (e.g., a Java stack, a native language stack, etc.) which stores the state of method invocations. Runtime data area 333 can also include a program counter “register” area for indicating the next instruction of the emulation language program to execute.

Referring still to FIG. 3, execution engine 334 executes bytecode instructions included in emulation class information 320. In one exemplary implementation, each bytecode instruction includes an opcode that indicates the operation to be performed and can include an operand that provides information associated with the operation. Execution engine 334 fetches an opcode and related information (e.g., operands and/or data stored in other areas) and performs the instructions indicated by the opcode. In one embodiment of the present invention, execution engine 334 includes an interpreter 335. Interpreter 335 interprets the emulation program bytecode (e.g., Java program) information and retrieves native language information (e.g., native language instructions).

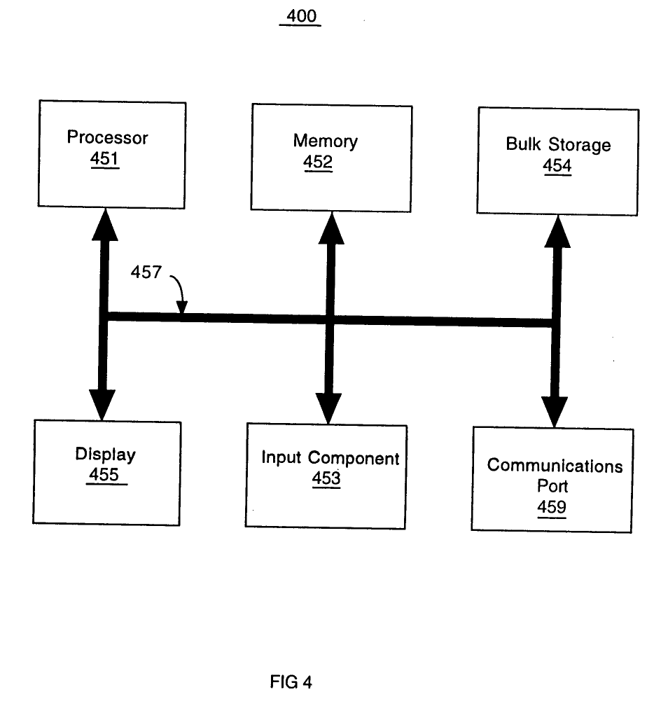

FIG. 4 is a block diagram of JNI testing system 400, one embodiment of a computer system on which the present invention can be implemented. For example, computer system 400 can be utilized to implement Java Native Language Interface (JNI) test method 100 and emulation and native language interface test system 300. JNI testing system 400 includes communication bus 457, processor 451, memory 452, input component 453, bulk storage component 454 (e.g., a disk drive), network communication port 459 and display module 455. Communication bus 457 is coupled to central processor 451, memory 452, input component 453, bulk storage component 454, network communication port 459 and display module 455. The components of JIN testing system 400 cooperatively function to provide a variety of functions, including performing a “machine” emulation with JNI testing capabilities in accordance with a present invention. Communication bus 407 communicates information. Processor 451 processes information and instructions, including instructions for testing a JNI. In one embodiment of the present invention, processor 451 performs a JNI testing process (e.g., method 10, 100, 200, etc). Memory 452 stores information and instructions, including instructions for testing the JNI. Bulk storage component 454 also provides storage of information. Input component 453 facilitates communication of information to computer system 450. Display module 455 displays information to a user. Network communication port 459 provides a communication port for communicatively coupling with a network.

Thus, the present invention facilitates efficient emulation language and native language interface testing. A present invention emulation and native language interface testing system and method provides an indication of JNI code problems. For example, the present invention provides the ability to generate code coverage results for JNI code (e.g., code that checks for NULL values from JNI memory allocation calls) without actually having to wait for the JVM to reach its maximum heap limit. The present invention verifies that code which uses JNI memory allocation calls is robust enough to handle a memory allocation failure, without causing subsequent core dumps, sigsegv issues, or memory violations. An appropriate message is also displayed to the user when the program runs into JNI issues. The simulated test behavior can be limited to a specific test mode, without having an effect on code when it is not running in the test mode. The failure simulations can also be limited to desired JNI function failures, such as a String allocation or an Object allocation. The present invention also facilitates reduction of product usage or testing confusion which may be caused by occasional memory allocation failures (e.g., when a JVM has run out of memory). Providing the simulated testing also reduces the likelihood that a JNI problem is misdiagnosed as an invalid pointer problem in the JNI code causing a core dump (e.g., instead of an out of memory issue not being properly checked for).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various modifications as are suited to the particular use contemplated. It is intended that the scope of the invention be defined by the Claims appended hereto and their equivalents.

1. A support contour for contacting and supporting a person in a sitting position, comprising:
relief areas defined by the support contour at locations adjacent to skin covering the ischial tuberosities, the greater trochanters and the coccyx and sacrum of the person sitting on the support contour; and
support areas adjacent to skin covering tissue masses on opposite lateral sides of the posterior buttocks and beneath the proximal thighs of the person; and wherein:
the relief areas and support areas are spaced relatively more away from and relatively more toward an anatomical shape of the person, respectively, to establish relatively less pressure on the skin in the relief areas and relatively more pressure on the skin in the support areas.

2. A support contour as defined in claim 1, wherein:
the relief areas substantially offload pressure on the skin covering the ischial tuberosities, the greater trochanters and the coccyx and sacrum; and
the support areas transfer sufficient force to the tissue masses at the lateral posterior buttocks and proximal thighs to substantially only support the person on the support contour at the support areas.

3. A support contour as defined in claim 1, wherein:
the relief area adjacent to the coccyx and sacrum substantially eliminates pressure on the skin adjacent to the coccyx and sacrum.

4. A support contour as defined in claim 3, wherein:
the relief area adjacent to the coccyx and sacrum is separated from the skin adjacent to the coccyx and sacrum.

5. A support contour as defined in claim 3, wherein:
the relief area adjacent to the coccyx and sacrum is spaced outwardly beyond an expected representation of the anatomical shape of the rear pelvic area of the person; and
the support areas at the opposite lateral posterior buttocks are spaced inwardly from the expected representation of the anatomical shape of the rear pelvic area of the person.

6. A support contour as defined in claim 1, wherein:
the relief area adjacent to the ischial tuberosities has sufficient longitudinal, transverse and vertical dimensions to establish the relatively less pressure on the skin covering the ischial tuberosities during forward and backward pivoting movement of the pelvis and upper torso of the person sitting on the support contour.

7. A support contour as defined in claim 6, wherein:
the dimensions of the relief area adjacent to the ischial tuberosities are also sufficient to establish the relatively less pressure on the skin covering the ischial tuberosities during lateral tilting movement of the upper torso of the person sitting on the support contour.

8. A support contour as defined in claim 1, wherein:
the relief area adjacent to the greater trochanters has sufficient longitudinal, transverse and vertical dimensions to establish the relatively less pressure on the skin covering the greater trochanters during movement within an anticipated range of normal contacting support positions of the person on the support contour.

9. A support contour as defined in claim 1, wherein:
the support areas on opposite lateral sides of the posterior buttocks contact the skin covering the tissue masses on the opposite lateral sides of the posterior buttocks to induce an upward component of support force on the pelvic area of the person.

10. A support contour as defined in claim 1, wherein:
the support areas beneath the proximal thighs function in a fulcrum-like manner to transfer weight from the legs distal to the proximal thighs in a lever-like manner through hip joints to the pelvic area of the person.

11. A support contour as defined in claim 10, wherein:
the location of the support areas beneath the proximal thighs establishes a mechanical advantage for transferring the weight from the distal legs to the pelvic area.

12. A support contour as defined in claim 1, comprising:
a back wall surrounding the rear pelvic area of the person;
a center cavity located directly below the ischial tuberosities of the person sitting on the support contour, the cavity curving downwardly and longitudinally forwardly and transversely inwardly from the back wall to a generally horizontal lowermost surface area of the cavity; and wherein:
the lowermost surface area of the cavity is at a location vertically spaced below the ischial tuberosities and has longitudinal and transverse dimensions relative to the ischial tuberosities to establish the relatively less pressure on the skin covering the ischial tuberosities during movement within an anticipated range of forward, backward and side to side movement of the upper torso of the person sitting on the support contour; and
the lowermost surface area constitutes one relief area.

13. A support contour as defined in claim 12, further comprising:
a lateral area on each opposite transverse side of the cavity and located transversely to the outside of and vertically below the greater trochanters of the person sitting on the support contour, each lateral area generally curving vertically downwardly and transversely inwardly from an outer periphery of the support contour to intersect transverse opposite sides of the cavity at a position above the ischial tuberosities of the person sitting on the support contour, the lateral relief area also extending longitudinally relative to the greater trochanters of the person sitting on the support contour; and wherein:
the lateral area has sufficient longitudinal, transverse and vertical dimensions to establish the relatively less pressure on the skin covering the greater trochanters during movement within an anticipated range of different contacting support positions of the person on the support contour; and
each lateral area constitutes one relief area.

14. A support contour as defined in claim 13, further comprising:
a posterior thigh protrusion area located beneath the skin covering the tissue masses at the posterior thighs of the person sitting on the support contour, each posterior thigh protrusion area located on transversely oppositely sides of a longitudinal midline through the support contour, each posterior thigh protrusion area positioned vertically above and longitudinally forward of each lateral area, each posterior thigh protrusion area defining an upwardly facing fulcrum-like contact surface at a posterior position of the thigh leg bone; and wherein:
the posterior thigh protrusion areas have sufficient longitudinal, transverse and vertical dimensions to establish the relatively greater pressure on the skin covering the tissue masses at the posterior thighs;
the fulcrum-like contact surfaces transferring force from the legs distal to the proximal thighs in a lever-like manner through the thigh bones to elevate the greater trochanters relative to the lateral areas while the person is sitting on the support contour; and
each posterior thigh protrusion area constitutes a support area.

15. A support contour as defined in claim 12, further comprising:
a channel area located directly behind the coccyx and sacrum of the person sitting on the support contour, the channel area extending downwardly and longitudinally forwardly from the back wall toward the lowermost surface area of the cavity at a transverse midline of the support contour; and wherein:
the channel area has dimensions extending longitudinally and transversely relative to the coccyx and sacrum to establish the relatively less pressure on the skin covering the coccyx and sacrum during an anticipated range of normal movement of the pelvic area of the person while sitting on the support contour; and
the channel area constitutes a relief area.

16. A support contour as defined in claim 15, further comprising:
a pelvic protrusion area located adjacent the skin covering the tissue masses at the opposite lateral posterior buttocks of the person sitting on the support contour, each pelvic protrusion area located at transversely oppositely spaced positions from the channel area, each pelvic protrusion area generally curving vertically downwardly and transversely and longitudinally inwardly from the back wall toward the lowermost surface area, each pelvic protrusion area terminating vertically above the lowermost surface area, each pelvic protrusion area defining a forwardly and upwardly facing contact surface to contact the skin covering the tissue masses at the lateral posterior buttocks; and wherein:
the forwardly and upwardly facing contact surfaces transferring force to the tissue masses at the opposite posterior buttocks to offload pressure from the skin covering the coccyx and sacrum while the person is sitting on the support contour; and
each pelvic protrusion area constitutes a support area.

17. A support contour as defined in claim 16, wherein:
the contact surfaces of the protrusion areas extend forwardly into the cavity compared to the channel area.

18. A support contour as defined in claim 12, further comprising:
a pelvic protrusion area located adjacent the skin covering the tissue masses at the opposite lateral posterior buttocks of the person sitting on the support contour, each pelvic protrusion area located at transversely oppositely spaced positions from a longitudinal midline through the support contour, each pelvic protrusion area generally curving vertically downwardly and transversely and longitudinally inwardly from the back wall toward the lowermost surface area, each pelvic protrusion area terminating vertically above the lowermost surface area, each pelvic protrusion area defining a forwardly and upwardly facing contact surface to contact the skin covering the tissue masses at the lateral posterior buttocks; and wherein:
the pelvic protrusion areas have sufficient longitudinal, transverse and vertical dimensions to establish the relatively greater pressure on the skin covering the tissue masses at the opposite lateral posterior buttocks;
the forwardly and upwardly facing contact surfaces transferring force to the tissue masses at the opposite posterior buttocks to support the posterior pelvic area substantially only at the pelvic protrusion areas while the person is sitting on the support contour; and
each pelvic protrusion area constitutes a support area.

19. A support contour as defined in claim 12, further comprising:
a posterior thigh protrusion area located beneath the skin covering the tissue masses at the posterior thighs of the person sitting on the support contour, each posterior thigh protrusion area located on transversely oppositely sides of a longitudinal midline through the support contour, each posterior thigh protrusion area positioned vertically above and longitudinally forward of the lowermost surface area, each posterior thigh protrusion area defining an upwardly facing fulcrum-like contact surface at a posterior position of the thigh leg bone; and wherein:
the posterior thigh protrusion areas have sufficient longitudinal, transverse and vertical dimensions to establish the relatively greater pressure on the skin covering the tissue masses at the posterior thighs;
the fulcrum-like contact surfaces transferring force from the legs distal to the proximal thighs in a lever-like manner through the thigh bones to the hip joints to support the anterior and lateral pelvic area while the person is sitting on the support contour; and
each posterior thigh protrusion area constitutes a support area.

20. A support contour as defined in claim 1 incorporated in a wheelchair seat cushion.

21. A support contour as defined in claim 1, further comprising a clearance area defined by the support contour at a location adjacent to a perineal area, to establish space for air circulation.

22. A method of configuring a support contour to contact and support a person sitting on the support contour, comprising:
defining relief areas in the support contour at locations adjacent to skin covering the ischial tuberosities, the greater trochanters and the coccyx and sacrum of the person sitting on the support contour;
defining support areas in the support contour at locations adjacent to skin covering tissue masses on opposite lateral sides of the posterior buttocks and beneath the proximal thighs of the person; and
positioning the relief areas and the support areas to establish a relatively greater clearance with respect to the ischial tuberosities, the greater trochanters and the coccyx and sacrum of the person sitting on the support contour compared to a relatively lesser clearance with respect to the tissue masses on the opposite lateral sides of the posterior buttocks and beneath the proximal thighs of the person sitting on the support contour.

23. A method as defined in claim 22, further comprising:
positioning the relief areas relative to the support areas to substantially offload pressure on the skin covering the ischial tuberosities, the greater trochanters and the coccyx and sacrum and to transfer the substantial majority of the support from the support contour to the tissue masses at the lateral posterior buttocks and proximal thighs.

24. A method as defined in claim 22, further comprising:
positioning the relief areas relative to the support areas to maintain the relatively less pressure on the skin covering the ischial tuberosities during forward and backward pivoting movement and lateral tilting movement of the upper torso of the person sitting on the support contour.

25. A method as defined in claim 22, further comprising:
positioning the relief areas relative to the support areas to maintain the relatively less pressure on the skin covering the greater trochanters during movement within an anticipated range of normal contacting support positions of the person on the support contour.

26. A method as defined in claim 22, further comprising:
positioning the support areas on opposite lateral sides of the posterior buttocks to contact the skin covering the tissue masses on the opposite lateral sides of the posterior buttocks to induce an upward component of support force on the pelvic area of the person.

27. A method as defined in claim 22, further comprising:
positioning the support areas beneath the proximal thighs at an elevated position relative to the relief areas below the greater trochanters, the support areas beneath the proximal thighs establishing a fulcrum from which the thigh leg bones transfer weight from the legs distal to the proximal thighs to elevate the greater trochanters relative to the relief area adjacent to the skin covering the greater trochanters.

28. A method as defined in claim 22, further comprising:
positioning the support areas relative to the relief areas to substantially support the person relative to the support contour by force transferred to the tissue masses at the lateral posterior buttocks and at the proximal thighs; and
positioning the relief areas relative to the support areas to substantially offload pressure on the skin covering the ischial tuberosities, the greater trochanters and the coccyx and sacrum.

29. A method as defined in claim 28, further comprising:
positioning the support areas on opposite lateral sides of the posterior buttocks to induce an upward component of support force on the tissue masses on the opposite lateral sides of the posterior buttocks of the person sitting on the support contour; and
positioning the support areas beneath the proximal thighs at an elevated position relative to the relief areas below the greater trochanters to establish a fulcrum from which the thigh leg bones transfer weight from the legs distal to the proximal thighs to elevate the greater trochanters relative to the relief area adjacent to the skin covering the greater trochanters of the person sitting on the support contour.

30. A method as defined in claim 22 applied to a seat cushion for wheelchair.

31. A method of supporting a person sitting on a support contour, comprising:
transferring the substantial majority of force associated with supporting the person on the support contour to skin covering tissue masses on opposite lateral sides of the posterior buttocks and beneath the proximal thighs of the person while the person is sitting on the support contour; and
substantially diminishing pressure and shear force from skin surrounding the ischial tuberosities, the greater trochanters and the coccyx and sacrum of the person seated on the support contour by transferring the sitting-associated force.

32. A method as defined in claim 31, further comprising:
substantially diminishing the force on the skin surrounding the ischial tuberosities during an anticipated range of forward, backward and side to side movement of the upper torso of the person while seated on the support contour.

33. A method as defined in claim 31, further comprising:
substantially diminishing the force on the skin surrounding the greater trochanters within an anticipated range of different contacting sitting positions of the person sitting on the support contour.

34. A method as defined in claim 31, further comprising:
substantially diminishing the force on the skin surrounding the coccyx and sacrum during an anticipated range of normal movement of the pelvic area of the person sitting on the support contour.

35. A method as defined in claim 31, further comprising:
transferring at least some of the sitting-associated force by inducing an upward component of force on the tissue masses on the opposite lateral sides of the posterior buttocks of the person sitting on the support contour.

36. A method as defined in claim 31, further comprising:
transferring weight from the legs distal to the proximal thighs in a lever-like manner through the thigh bones as force to elevate the greater trochanters while the person is seated on the support contour.

37. A method as defined in claim 31, applied to supporting the person from the support contour of a wheelchair seat cushion.

38. A support contour as defined in claim 1 incorporated in a support structure for a cushion, the support structure comprising a matrix of resilient adhered-together plastic beads.

39. A support contour as defined in claim 38, wherein the adhered-together plastic beads define spaces between the beads to establish permeability for air movement within the support structure.

40. A method as defined in claim 22, further comprising:
incorporating the support contour in a support structure of a cushion; and
forming the support structure from a matrix of resilient adhered-together plastic beads.

41. A method as defined in claim 40, further comprising:
allowing air movement within the support structure through spaces between the adhered-together plastic beads.

42. A method as defined in claim 31, further comprising:
incorporating the support contour in a support structure of a cushion; and
forming the support structure from a matrix of resilient adhered-together plastic beads.

43. A method as defined in claim 42, further comprising:
allowing air movement within the support structure through spaces between the adhered-together plastic beads.
